(19) United States
(12) Patent Application Publication
(10) Pub. No.: US 2009/0234960 A1
(43) Pub. Date: Sep. 17, 2009

(54) Protocol processing apparatus and processing method

(75) Inventors: Satoshi Kamiya, Tokyo (JP); Hiroshi Ueno, Tokyo (JP); Kiyohisa Ichino, Tokyo (JP); Motoo Nishihara, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 12/382,199

(22) Filed: Mar. 11, 2009

(30) Foreign Application Priority Data
Mar. 12, 2008 (JP) 2008-063256

(51) Int. Cl. G06F 15/16

(52) U.S. Cl. 709/230

(57) ABSTRACT

A protocol processing apparatus includes: a tag extracting section configured to output a tag data and an input data based on the input data and a protocol data of the input data; a format sheet configured to store a format data common to protocols; and a processing unit configured to refer to said format sheet to execute processes to the tag data and the input data based on the format data, and to output an execution result, and an output data. The tag data is defined for every type of protocol and is managed in a common format to protocols of a plurality of layers.

### INCORPORATION BY REFERENCE

This application claims priority on convention based on Japanese Patent Application No. 2008-063256. The disclosure thereof is incorporated herein by reference.

### TECHNICAL FIELD

The present invention relates to a protocol processing apparatus and a processing method, and particularly to a protocol processing apparatus and a processing method for processing data in protocols of a plurality of layers.

### BACKGROUND ART

Conventionally, communication protocol processing of a layer structure has a closed processing mechanism for each layer, to realize protocol processing for each layer. However, in a configuration having the processing mechanism for each layer, it is difficult to downsize a processing apparatus and to realize increase of a processing speed. Thus, in recent network processing, a configuration that data processing is executed over a plurality of layers, that is, a configuration of cross layer processing (multilayer processing) has appeared, in place of a conventional configuration that the processing is closed for each layer.

In the cross layer processing, a process of a data link layer (layer 2) and a process of a network layer (layer 3) are compositely dealt, as represented by a multilayer switch in which a bridge and a router are integrated, and a processing target is extended to include a process of a transport layer (layer 4).

In the protocols in layers from the layer 2 to the layer 4, various data regions are arranged in a header and a payload, at fixed positions from the head position of a packet or a frame. A packet classification, routing of data, and passage determination (filtering) are executed by using a plurality of data in these data regions, for example, as shown in Japanese Patent Application Publication (JP-P2001-251351A: related art 1).

In case of TCP/IP (Transmission Control Protocol/Internet Protocol), a process for simultaneously identifying an IP packet header field and a TCP packet header field of five kinds of a source IP address of a IP layer (layer 3), a destination IP address, a protocol, a source port number of a TCP layer (layer 4), and a destination port number, and a process for identifying a TCP connection are executed by a firewall device.

Furthermore, a cross layer processing for data processing has appeared, including data of an application layer which is higher than the layer 5, in addition to data of the layer 4 or lower. Protocol processing is known which operates on a transport layer (layer 4), as an example of protocol processing of the application layer. For example, SIP (Session Initiate Protocol), SMTP (Simple Mail Transfer Protocol), and HTTP (Hyper Text Transfer Protocol) are present. A method which is a processing instruction data on a protocol (Japanese Patent Application Publication (JP-P2003-304293A: related art 3), a response to the method, and a response code are described in protocols of these application layers in the ASCII code, and their appearance portions are freely changed inside the payload in a layer 4 protocol (an upper layer protocol payload).

Furthermore, as another example, XML (eXtensible Markup Language) and HTML (Hyper Text Markup Language) are known as a structured data format transferred by the protocols. The XML and the HTML are a kind of markup language, and have a “tag” as an instruction character sequence related to a data description in a document. Various data, types of the data, and regions of the data are specified by the tag.

In the cross layer processing, it is necessary to execute a process for detecting a data region and an interpreting process in the protocols of layers from the layer 2 to the layer 4; a process for detecting and interpreting a method, a response, and a response code as processing instruction data of the protocols in the application layers from the layer 5 to the layer 7 such as SIP, HTTP, SMTP; and a process for detecting a tag and tag contents specified by the tag in the markup language such as XML, and a structural analyzing process.

In a network apparatus, a dedicated hardware sometimes executes a process of the layer 3 or the layer 4. In addition, in another network apparatus, a network processor unit (NPU) specialized for executing the process of the layer 3 or the layer 4 is often used. The network processor realized by a general-purpose CPU core or a RISC (Reduced Instruction Set Computer) having dedicated commands, and a header portion of network data is regarded as a calculation target.

In addition, conventionally, the process in the layer 4 or higher are generally executed by a network terminal and a server, and a general-purpose central processing unit (CPU) is generally used for the process. When a network apparatus arranged in a network executes the process in the layer 4 or higher, the general-purpose CPU and a combination of the general-purpose CPU and a dedicated hardware are used.

In Japanese Patent Application Publication (JP-P2003-304293A: related art 3) is described a high-speed packet processing method in a multilayer, in which a packet relaying apparatus such as a router and a layer 2-3 switch executes a packet relaying process on a packet determined to be relayed by routing in the layers 2 and 3 by an conventional ASIC and filtering the packet in lower layers, by further providing a plurality of filtering functions in higher layers by ASIC and a network processor for each layer or on the basis of analyzed contents of the packet. However, in this related art 3, a process in the layers from the layer 2 to the layer 4 and a process in the layer 5 and higher are executed by different processing blocks such as the ASIC and the network processor, resulting in increase of processing circuit scale.

In Japanese Patent Application Publication (JP-P2007-500886A: related art 4) is described a configuration of a multi-core CPU for use in network processing. However, this related art 4 does not describe a method for uniformly executing the process in the layers from the layer 2 to the layer 4 and the process in the layer 5 or higher.

In Japanese Patent Application Publication (JP-P2001-251351A: related art 1) is disclosed a processing configuration as an example in which two different types of the layer processes of MPLS (Multi-Protocol Label Switch) and IP are integrally executed and processing results are expressed in a same format and processed by a header controller.

In addition, in Japanese Patent Application Publication (JP-A-Heisei 8-195783: related art 2) is disclosed a method that individual processing functions in different layers are called by using an identical method name in the protocol processing of a plurality of layers. However, both of the related arts 1 and 2 can be realized only under the condition that a storage position of header data in the protocol is fixedly known. Thus, nothing is disclosed on processes including a process of a protocol in which appearance positions are not fixed as in tags of HTML and XML, and an integrated process of the above processes is also not disclosed.

As described above, a conventional apparatus for simultaneously processing protocols of layers from the layer 2 to the layer 7 has the following problems.

In a conventional configuration provided with processing units for each layer, in case of processing a plurality of layers in a cross-layer manner, detection methods of data regions are different and the processing is inefficient. The protocol of data and its format included in each layer is independently determined in formulating the protocol. For this reason, when the protocols of the plurality of layers are processed in a cross-layer manner, processing overhead for realizing a unified process between the layers is generated because there is a difference between data structures. For example, when SIP data is transferred on a packet network which uses the Ethernet (registered trademark), IP, and UDP (User Datagram Protocol) for the layers 2, 3, and 4, a field in a predetermined data position from a head position of a packet is referred in the layer 2 to the layer 4 in order to recognize data structures. However, in the SIP on the UDP, the method (INVITE, ACK, REGISTER, and so on) is recognized by detecting a specific word followed by a line head or/and space characters continuing from the line head. As described above, a method for recognizing a data region of header data and the method depends on the protocol. For this reason, it is not easy to uniformly or integrally process data detected in the layers up to the layer 4 and data detected in the layer 5 or higher.

The processing to be executed is different in each layer in addition to the difference in the formats of data in each layer, and thus a common processing procedure and a common processing procedure notation have been not established. Especially, a process for confirming consistency of the formats in respective protocols and a process for extracting data have been not unified, and thus these processes are inefficient. Accordingly, it is required to retain processing circuits individually in respective layers or to describe the process by using the processing procedure notation specific in each layer. It is not easy to integrally execute the respective layer processing.

### SUMMARY

This invention provides a protocol processing apparatus and a processing method, in which a plurality of layer protocol processes can be integrally and uniformly executed so as to be able to downsize and to realize increase of a processing speed.

In an aspect of the present invention, a protocol processing apparatus includes: a tag extracting section configured to output a tag data and an input data based on the input data and a protocol data of the input data; a format sheet configured to store a format data common to protocols; and a processing unit configured to refer to said format sheet to execute processes to the tag data and the input data based on the format data, and to output an execution result, and an output data. The tag data is defined for every type of protocol and is managed in a common format to protocols of a plurality of layers.

In another aspect of the present invention, a protocol processing method is achieved: by defining a tag data for every type of protocol to indicate a data region in the protocol; and by managing the tag data for a plurality of layer protocols in a common format such that processes for a plurality of layer protocol are executed uniformly.

According to the present invention, processes in protocols of a plurality of layers can be uniformly executed by employing a common data format based on a tag. In this way, the present invention provides an apparatus and a method in which a processing apparatus can be downsized and simplified and increase of processing speed can be realized.

### BRIEF DESCRIPTION OF DRAWINGS

The above and other objects, advantages and features of the present invention will be more apparent from the following description of certain embodiments taken in conjunction with the accompanying drawings, in which:

FIG. 1 is a block diagram showing a configuration of a protocol processing apparatus according to one exemplary embodiment of the present invention;

FIG. 2 is a block diagram showing the configuration of a tag extracting section in the protocol processing apparatus in the exemplary embodiment;

FIG. 3 is a flowchart schematically showing an operation procedure of data processes executed by sections of the protocol processing apparatus;

FIG. 4 is a flowchart showing a registering process of data in the operation procedure; and

FIG. 5 is a flowchart showing a processing procedure of processes.

### EXEMPLARY EMBODIMENTS

Hereinafter, a protocol processing apparatus will be described in detail with reference to the attached drawings.

At first, an outline of the present invention will be explained. In order to integrally or uniformly execute protocol processes of a plurality of layers, in a protocol processing apparatus according to the present invention, a tag is defined for each protocol type as an indicator of an data region in each layer protocol and a processing procedure is managed in a common form to the tags to the respective layer protocols. The protocol processes of the plurality of layers include at least a protocol process for the layer 4 or less and a protocol process for the layer 5 or more.

The identification tag data database and a format sheet can be set from an outside. In the present invention, a tag extracting section is added to identify and extract a tag in each layer protocol.

When data described in a structured data format is supplied in which a tag is explicitly designated, the tag extracting section has a function for extracting the tag and tag contents as a data region designated by the tag. When data described in a structured data format is supplied in which a tag is explicitly designated by using brackets < > as in XML (eXtensible Markup Language) or HTML (Hyper Text Markup Language), the tag extracting section extracts the tag and tag contents as the data region designated by the tag. In addition, when protocol data is supplied in which a tag is not explicitly designated by using the brackets < >, the tag extracting section has a function for identifying the tag and tag contents on a basis of a specific word followed by a line head or/and space characters (space, tab, and carriage return) continuing from the line head; and a character sequence followed by the specific word (an end position is designated by the carriage return), and for extracting the identified tag and tag contents.

When SIP (Session Initiate Protocol) data, SMTP (Simple Mail Transfer Protocol) data, or HTTP (Hyper Text Transfer Protocol) data is inputted, the tag extracting section identifies a tag and tag contents on a basis of a specific word followed by a line head or/and space characters (space, tab, and carriage return) continuing from the line head, and a character sequence followed by the specific word (an end position is designated by the carriage return) and extracts the identified tag and tag contents. In addition, when packet data is supplied, the tag extracting section has a function for identifying a tag and tag contents as a data region based on position data from a head of the packet data, and for extracting the identified tag arid tag contents. In this case, although being often seen in a protocol of the layer 4 or less, a section for acquiring the position data is provided, a data region is specified on the basis of the acquired position data, and a tag name corresponding to the region is given.

Moreover, in the present invention, a consistency confirming process for tag data to a designated tag in each layer protocol; a process for extracting tag contents of the designated tag from the supplied data; a process for searching the extracted tag contents; and a process for outputting a result of the searching process, are executed, as a processing procedure for the tag in each layer protocol. When executing the consistency confirming process for the tag data, at least a part of a schema check of XML is used. In the searching process for an extracted tag, search target data in a portion to which the searching process is executed can be set from an outside.

According to the present invention, it is possible to reduce a circuit scale by using a common processing circuit in the tag extracting section and the above process executing circuit through sharing the tag in the tag extracting section. In the present invention, at first, the tag data of XML and HTML, the methods of SIP, HTTP, SMTP, responses to the methods, and the response codes, and a field of packet header are identified and extracted as a common “tag”. In addition, when a tag name is not explicit as in the packet header field and the packet payload field, the processing of the tag is shared by adding the tag name to make the tag possible to be explicitly designated. Accordingly, the manipulation of data based on the tag is shared in an information processing apparatus 1.

Also, it is possible to simplify a processing circuit by using a common processing circuit in the tag extracting section and the above process executing circuit by sharing a processing procedure through employment of a common data format based on the tag and to reduce circuit scale on the basis of integration of a plurality of the processing circuits.

Moreover, it is possible to simplify processing instruction data by unifying the processing instruction data stored in the format sheet 21, through employment of the common data format based on the tag.

### First Exemplary Embodiment

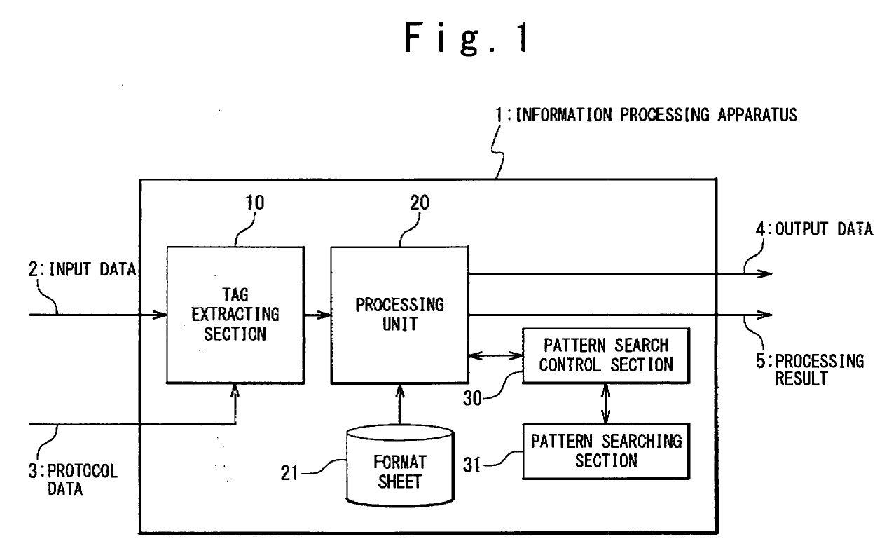

FIG. 1 is a block diagram schematically showing a configuration of an information processing apparatus according to a first exemplary embodiment of the present invention. The information processing apparatus 1 of the present exemplary embodiment includes a tag extracting section 10, a processing unit 20, a format sheet 21, a pattern search control section 30, and a pattern searching section 31. Input data 2 and protocol data 3 are supplied from an outside to the information processing apparatus 1, the respective components 10, 20, 21, 30, and 31 operate to execute processes described later, and then output data 4 and a processing result 5 are outputted to an outside.

Here, a packet data for communication, a protocol-specified packet data sequence, and a data stream in an upper protocol reproduced from a packet sequence such as a TCP data stream can be shown as the input data 2. For example, an Ethernet frame, an IP packet, and a TCP/UDP packet can be shown as the packet data for communication. SIP (Session Initiate Protocol) data, SMTP (Simple Mail Transfer Protocol) data, HTTP (Hyper Text Transfer Protocol) data, and XML (eXtensible Markup Language) data transferred under the protocols can be shown as the data stream.

The protocol data 3 includes data showing one of a plurality of protocols which is related to the input data 2. For example, when the input data 2 is an Ethernet frame, “Ethernet” is shown to the information processing apparatus 1 as the protocol data 3. In addition, when it is determined that the input data 2 is the Ethernet frame, the input data 2 includes IPv4 (Internet Protocol version 4) packet, the IPv4 packet includes a TCP data, and the TCT includes a SIP data, “Ethernet, IPv4, TCP, SIP” can be may be indicated to the information processing apparatus 1 as the protocol data 3.

As the output data 4, data of the same type as that of the input data 2 is outputted. Off course, the input data 2 may be processed for a part of the input data 2 to be converted in the information processing apparatus 1.

The processing result 5 indicates a process result in the information processing apparatus 1. For example, as an example of the result, data of one or more protocols to which the inputted packet data belongs, a flow identifier for identifying a packet sequence to which the TCP or UPD packets belong, a result of format check to the input data 2 (adapted or non-adapted), a passage determination of the input data 2 (passed or discarded), and an output route data of the input data 2 (an physical output port number in a switch or a router) can be shown.

The tag extracting section 10 identifies and extracts a tag data 15 in a protocol corresponding to the protocol data 3 from the input data 2 and the protocol data 3 supplied to the information processing apparatus 1, identifies an upper layer protocol included in the input data 2, and notifies the input data 2 and the extracted tag data 15 to the processing unit 20. Here, the tag data 15 is a data region of the input data 2, and includes an element name (to be referred to as a “tag”) surrounded by the brackets < > and contents (to be referred to as “tag contents”) designated by the tag, as in XML and HTML (Hyper Text Markup Language).

It should be noted that in the present exemplary embodiment, a method in HTTP (GET, HEAD, and PUT and so on), a header and a value in the header included in the method and a response to the method, and the response and a response code can be regarded as the tag data of the tag and the tag contents, even in protocols not using the brackets < >. Even in case of SIP, a method (INVITE, ACK, REGISTER, and so on), a response to the method and a response code can be regarded as the tag data of the tag and the tag contents. In other words, a specific word followed by a line head or/and space characters (space, tab, and linefeed code) continuing from the line head, and a character sequence followed by the specific word (an end position is designated by a carriage return or the like) can be also regarded as the tag data of the tag and the tag contents.

Moreover, a field in a header of the packet can also be regarded as the tag data. In this case, although the tag (element name) does not explicitly appear on the input data 2, a name defined by a protocol can be regarded as the tag. A packet header field can be identified on the basis of a byte position and a bit position from the head of the packet and a byte length and a bit length in accordance with a format of the packet. For example, a 2-bytes field from the 13^{th} byte of the Ethernet frame (when a head byte of the Ethernet frame in a network byte order (belonging to a destination MAC address) is a first byte) is a Length/Type field in the Ethernet (registered trademark). In this case, “Ethernet/Type” can be regarded as the tag. When the Ethernet frame accommodates the IPv4 packets as an upper layer protocol, 0800H (in the hexadecimal notation) is set to a Type field. Accordingly, the tag contents of the tag “Ethernet/Type” is 0800H.

The processing unit 20 checks the tag data 15 and the input data 2 supplied from the tag extracting section 10 on the basis of format data stored previously in the format sheet 21, executes a process for confirming consistency with the format, a process for extracting one or more tag values designated by format data described in the format sheet 21, and a process for searching the one or more extracted tag values, and outputs the output data 4 and the processing result 5 to an outside of the information processing apparatus 1. If the above processes can be changed based on the format data of the format sheet 21, the processing unit 20 may be a central processing unit (CPU), a dedicated sequence circuit, or other realizable circuit configuration.

The format sheet 21 is a database in which instructions and data for the consistency confirming process to the input data 2 and the tag data 15, the tag values to be extracted, and the searching process of the extracted tag values are described so as to be executed by the processing unit 20. In the format sheet 21, names of tags, and data of formats are described in a common form for the consistency confirming process in each protocol. Also, the instructions for the extraction of the tag and the searching process of the extracted tag are also described in a common form. For example, an XML Schema notation or a form of the extended XML Schema notation, or a structured form as binary data can be preferably used as a common form.

In response to an instruction from the processing unit 20, the pattern search control section 30 instructs the pattern searching section 31 to execute a process for searching a designated pattern, and returns the search result from the pattern searching section 31 to the processing unit 20. The pattern searching section 31 executes the searching process of the designated pattern in response to the instruction from the pattern search control section 30, and returns the search result to the pattern search control section 30. The pattern searching section 31 includes TCAM (Ternary Content Addressable Memory), a hardware circuit dedicated to the search, or/and a processor dedicated to the search, executes the searching process by using one or more search keys, and executes an LPM (Longest Prefix Match), an Exact Match, and a match/search process by using a combination of a plurality of fields.

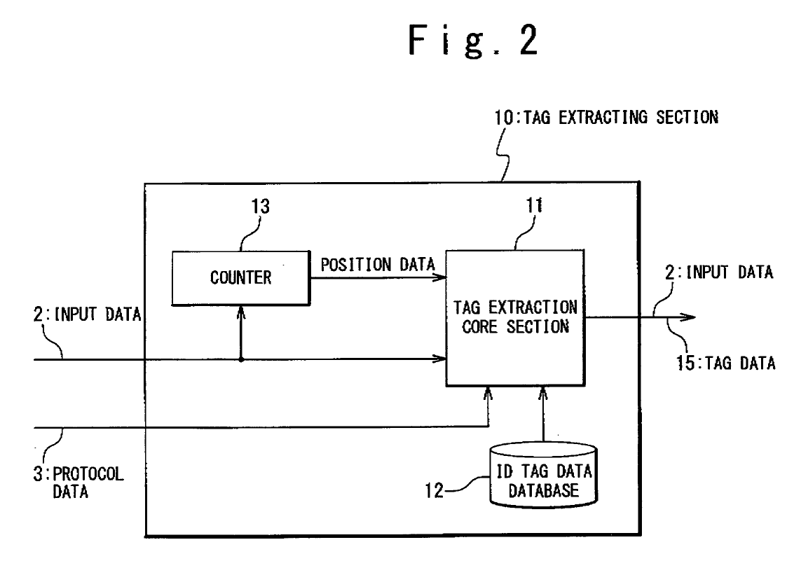

FIG. 2 is a block diagram schematically showing a configuration of the tag extracting section 10 included in the information processing apparatus 1. As shown in FIG. 2, the tag extracting section 10 mainly includes a tag extraction core section 11, an identification tag data database 12, and a counter 13.

The tag extraction core section 11 refers to the identification tag data database 12 to identify the tag data 15 from the input data 2, and outputs the identified tag data together with the input data 2. Here, when data in which a tag is specified by the brackets < > as in XML and HTML is supplied as the input data 2, the tag extraction core section 11 identifies the tag from the input data 2 on the basis of the brackets and a tag name. In addition, when data not using the brackets < > as in SIP, HTTP, and SMTP is supplied as the input data 2, the tag extraction core section 11 identifies a specific word followed by a line head or/and space characters (space, tab, and carriage return) continuing from the line head, and a character sequence followed by the specific word as the tag data. Moreover, when data of a type in which a field is specified in a packet on the basis of a byte position or a bit position in a packet header and a payload is supplied as the input data 2, the tag extraction core section 11 specifies the byte position and the bit position from the input data 2 by using position data from the counter 13, and uses the position data for tag identification.

The identification tag data database 12 stores a tag of the input data 2 to be identified for each protocol.

The counter 13 counts the number of bytes and number of bits of the input data 2 and outputs these counted values as the position data of the input data 2, and the count values are used in the tag extraction core section 11 when a packet is supplied as the input data 2.

As far as the tag searching process is possible, the tag extracting section 10 may include the TCAM, a hardware circuit dedicated to the extraction (a pattern detecting engine), or/and a processor dedicated to the extraction or a central processor unit.

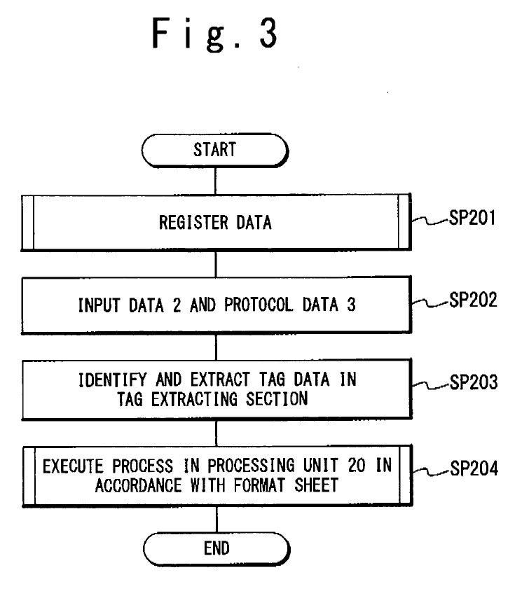

Next, an operation of the information processing apparatus in the present exemplary embodiment will be described with reference to FIGS. 3, 4 and 5.

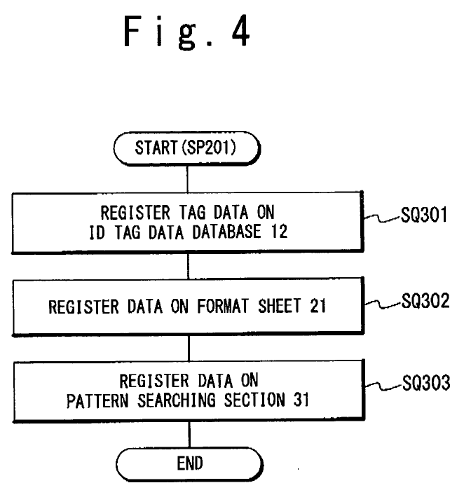

FIG. 3 is a flowchart schematically showing a data processing operation executed by the information processing apparatus 1. At step SP201, the information processing apparatus 1 firstly registers the identification tag data to the identification tag data database 12, data to the format sheet 21, and data to the pattern searching section 31. Details of the data registration at step SP201 will be described later with reference to FIG. 4.

Next, at step SP202, the input data 2 and the protocol data 3 are supplied from an outside. The process flow advances to step SP203, the tag extraction core section 11 of the tag extracting section 10 refers to the identification tag data database 12 on the basis of the protocol data 3 to identify and extract the tag data 15 from the input data 2. Here, when the input data 2 is supplied to allow a tag to be specified on the basis of a byte position or a bit position in a packet header and a payload but not to explicitly include a tag name in the data, the tag extraction core section 11 identifies and extracts the tag by using the input data 2 and the position data measured by the counter 13. In addition, when the input data 2 is supplied in a data form in which the tag name (such as the XML and HTML, SIP and HTTP, and SMTP) is explicitly included, the tag extraction core section 11 identifies and extracts a tag by using the explicit tag name. The extracted tag data is outputted to the processing unit 20 together with the input data 2.

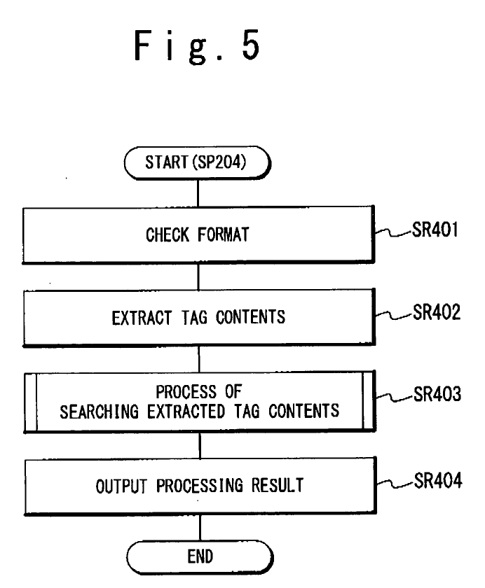

At step SP204, the processing unit 20 executes processes to the input data 2 and the tag data 15 extracted in the tag extracting section 10 in accordance with the format sheet 21. Upon completion of the processes by the processing unit 20, a series of the operation procedure of data processing (step SP201 to SP 204) completes. Referring to FIG. 5, details of processes executed by the processing unit 20 at step SP204 will be described later.

FIG. 4 is a flowchart showing a registration procedure of data at step SP201 (FIG. 3). The tag extracting section 10 of the information processing apparatus 1 firstly registers the tag data 15 to be identified and extracted by the tag extracting section 10 to the identification tag data database 12 at step SQ301. Subsequently, data is registered to the format sheet 21 in the information processing apparatus 1 at step SQ302. Subsequently, four items [1] to [4] are performed in the data registration.

[1] Data for consistency confirmation in a format is registered to the format sheet 21. For example, when data to be extracted from the input data 2 to the information processing apparatus 1 is the XML data, tag data for checking a schema such as the XML Schema is registered as the data for consistency confirmation in format to the format sheet 21. In addition, when data supplied from the input data 2 is non-XML data, such as the SIP, the HTTP, and the SMTP, the tag data and format data of the tag are registered. When data supplied from the input data 2 is a packet data, its tag data and format data of the tag are registered since a field name and a field value of a field specified on the basis of a position from a head byte of a packet as a field in the packet header is defined as “tag”. A common form is employed as a registration form of the XML tag, a tag of the non-XML data, or a tag of packet data as a check target.

[2] A tag extracted from the input data is registered to the format sheet 21. A common form is employed as a registration form of the XML tag, a tag of the non-XML data, or a tag of packet data as an extraction target.

[3] A tag searched by the pattern searching section 31 is registered to the format sheet 21. A common form is employed as the registration form of the XML tag, the tag of the non-XML data, or the tag of the packet data as a search target.

[4] The output data 4 and the processing result 5 outputted from the information processing apparatus 1 are registered to the format sheet 21. A same common form as that of the tag is employed as a registration form of data as an output target.

Next, in step SQ303, data of a search target based on a tag extracted from the input data 2 is registered to the pattern searching section 31 by the processing unit 20. For example, when a physical output port for packet transmission based on a destination IP address is to be searched, the physical output port number is registered as a search result by using the IP address as a search key. A SIP-URL of SIP, a URL of HTTP, and the like are other examples of registration of the search key. After the processing, detailed processing for the data registration (step SP201) completes.

FIG. 5 is a flowchart showing a detailed procedure for executing processes by the processing unit 20 (in accordance with the format sheet 21 step SP204 in FIG. 3).

At step SR401, the processing unit 20 firstly checks a format of input data in accordance with the format sheet 21. In this format check, it is checked in a protocol for the input data 2 that all of necessary tags are supplied and that the input data 2 includes only tags permitted to exist. Here, in case of XML, the check is executed on the basis of the schema. Also, in case of HTML, HTTP, SMTP, SIP, and the like, or in case of not including a tag name in the input data, the same check as the schema check of XML is executed to the tag set explicit in the identification and extraction of the tag data executed as step SP203.

When an inspection rule for non-structured data such as a method and a response of the SIP, the HTTP, and the SMTP and a header field or a payload field of a packet are simple, as compared to structured data described in the XML, the check is executed by a check method based on a subset of a validity check method for tag data of the XML.

The process flow advances to step SR402, and the processing unit 20 extracts tag contents of one or a plurality of tags specified based on the input data 2 in accordance with the format sheet 21. The check of input data and the extraction of the tag contents at steps SR401 and SR402 can be executed by sequentially managing a state transition in units of the input data.

Next, the process flow advances to step SR403, and the processing unit 20 executes a process for searching the extracted tag contents in accordance with the format sheet 21. In that execution, the process may be executed by the processing unit 20 and may be executed by using the pattern search control section 30 and the pattern searching section 31. The result of the searching process based on the extracted tag contents is stored in the processing unit 20.

Then, the process flow advances to step SR404, and the processing unit 20, outputs the processing result 5 to an outside of the information processing apparatus 1 in accordance with the format sheet 21, by using the search result of the extracted tag contents. According to the above process, detailed process at step SP204 completes.

As described above, according to the configuration of the present exemplary embodiment, the tag data of the XML and the HTML, the methods of the SIP, the HTTP, and the SMTP, the responses to the methods, and the fields of the response code and the packet header are extracted after identified as common “tags” in data.

In addition, when a tag name is not explicit as in the packet header field and the payload field, a process for tags is shared by permitting the tags to be specified by adding a tag name. According to this, a method for handling data on the basis of the tag in the information processing apparatus 1 is shared, and the sharing of a processing circuit produces an effect of reduction of a circuit scale.

Moreover, a processing procedure is shared by the processing unit 20 and the format sheet 21 by sharing a data form of the tag. Therefore, the validity check method of tag data based on the schema check of the XML can be applied to validity check methods of tag data extracted from data of other data forms. Thus, a processing circuit can be simplified by sharing the processing procedure and a circuit scale can be reduced by integrating a plurality of processing circuits. Furthermore, integration of the processing instruction methods for the storage in the format sheet 21 leads simplification of the processing instruction data.

Furthermore, there are many cases where the non-structured data such as the methods and responses of the SIP, the HTTP, and the SMTP and an verification rule in the header field or the payload field of the packet are relatively simple, compared to the structured data described by the XML in general. Therefore, the cases can be handled by a subset of the validity check method for tag data of the XML.

The exemplary embodiment of the present invention has been described in detail in the above description referring to the drawings, however, a concrete configuration is not limited to the present exemplary embodiment and a modification of designing within a scope of the invention is included in the present invention.

The present invention can be applied to a packet processing apparatus in a network, and also applied to a packet processing apparatus in an apparatus for processing a plurality of layer protocols in a cross-sectional manner. The present invention can be also applied to a multilayer switch and a firewall device, a load balancing apparatus, a gateway device, a border gateway function that is a gateway device for voice packets, the GGSN (Gateway GPRS (General Packet Radio Service) Service Node), and the SGSN (Serving GPRS Service Node).

While the present invention has been particularly shown and described with reference to the exemplary embodiments thereof, the present invention is not limited to these exemplary embodiments. It will be understood by those of ordinary skill in the art that various changes in form and details may be made therein without departing from the spirit and scope of the present invention as defined by the claims.

What is claimed is:

1. A protocol processing apparatus comprising:
a tag extracting section configured to output a tag data and an input data based on the input data and a protocol data of the input data;
a format sheet configured to store a format data common to protocols; and
a processing unit configured to refer to said format sheet to execute processes to the tag data and the input data based on the format data, and to output an execution result, and an output data,
wherein the tag data is defined for every type of protocol and is managed in a common format to protocols of a plurality of layers.

2. The protocol processing apparatus according to claim 1, wherein a processing procedure of the processes of the tags is managed for a plurality of layer protocols in a common format.

3. The protocol processing apparatus according to claim 1, wherein the processes include protocol processes of layer 4 and lower layers and protocol processes of layer 5 and higher layers.

4. The protocol processing apparatus according to claim 1, wherein said tag extracting section comprises;
an identification tag data database configured to store tag data for each protocol; and
a tag extraction core section configured to refer to said identification tag data database based on the input data and the protocol data to retrieve tag data and output the tag data and the input data.

5. The protocol processing apparatus according to claim 1, wherein the common format is changed from an outside of said protocol processing apparatus.

6. The protocol processing apparatus according to claim 1, wherein said tag extracting section extracts the tag data of a tag and tag contents as a data region specified by the tag when the input data whose tag is described in a structured data format explicitly designated is supplied.

7. The protocol processing apparatus according to claim 1, wherein said tag extracting section extracts the tag data based on a specific word followed by a line head and/or space characters continuing from the line head and a character sequence followed by the specific word, when the input data whose tag is not explicitly designated is supplied.

8. The protocol processing apparatus according to claim 1, wherein said tag extracting section extracts the tag data based on a position data from a head of a packet data, when the packet data is supplied as the input data.

9. The protocol processing apparatus according to claim 1, wherein said tag extracting section extracts the tag data based on a specific word followed by a line head and/or space characters continuing from the line head and a character sequence followed by the specific word, when the input data in XML (eXtensible Markup Language) or HTML (HyperTextMarkup Language) is supplied.

10. The protocol processing apparatus according to claim 1, wherein said tag extracting section extracts the tag data based on a specific word followed by a line head and/or space characters continuing from the line head and a character sequence followed by the specific word, when an SIP-(Session Initiate Protocol) data, an SMTP (Simple Mail Transfer Protocol) data or an HTTP (HyperText Transfer Protocol) data are supplied.

11. The protocol processing apparatus according to claim 2, wherein the processes include a tag data consistency confirming process of the tag specified in each of the layer protocols, a process for extracting tag contents of the tag data specified from the input data, a searching process of the extracted tag contents, and a process for outputting a searching result.

12. The protocol processing apparatus according to claim 11, wherein at least a part of schema check of XML is used in execution of the consistency confirming process of the tag contents.

13. A protocol processing method comprising:
defining a tag data for every type of protocol to indicate a data region in the protocol; and
managing the tag data for a plurality of layer protocols in a common format such that processes for a plurality of layer protocol are executed uniformly.

14. The protocol processing method according to claim 13, further comprising:
managing an execution procedure of processes to the tag data in a common format to the plurality of layer protocols.

15. The protocol processing method according to claim 13, wherein the processes for the plurality of layer protocols includes protocol processes of layer 4 and lower layers and protocol processes of layer 5 and higher layers.

16. The protocol processing method according to claim 13, further comprising:
extracting the tag data from an input data for each of the plurality of layer protocols.

17. The protocol processing method according to claim 16, wherein said extracting comprises;
extracting the tag data of a tag and tag contents as a data region specified by the tag when the input data whose tag is described in a structured data format explicitly designated is supplied in.

18. The protocol processing method according to claim 16, wherein said extracting comprises:
extracting the tag and the tag contents based on a specific word followed by a line head and/or space characters continuing from the line head and a character sequence followed by the specific word, when the input data whose tag is not explicitly designated is supplied.

19. The protocol processing method according to claim 16, wherein said extracting comprises:
extracting the tag data based on a position data from a head of a packet data, when the packet data is supplied as the input data.

20. The protocol processing method according to claim 16, wherein said extracting comprises:
extracting the tag data based on a specific word followed by a line head and/or space characters continuing from the line head and a character sequence followed by the specific word, when a data in XML (eXtensible Markup Language) or HTML (HyperTextMarkup Language) is supplied.

21. The protocol processing method according to claim 16, wherein said extracting comprises:
extracting the tag data based on a specific word followed by a line head and/or space characters continuing from the line head and a character sequence followed by the specific word, when an SIP (Session Initiate Protocol) data, an SMTP (Simple Mail Transfer Protocol) data or an HTTP (HyperText Transfer Protocol) data are supplied.

22. The protocol processing method according to claim 14, further comprising:
sequentially executing a tag data consistency confirming process of a tag specified in each of the plurality of layer protocols, a process for extracting the tag contents of the tag specified from the supplied data, a searching process of the extracted tag contents, and a process for outputting a searching result based on the execution procedure.
